(19) United States
(12) Patent Application Publication
(10) Pub. No.: US 2019/0385544 A1
(43) Pub. Date: Dec. 19, 2019

(54) DEVICE AND METHOD FOR BRIGHTNESS COMPENSATION, MEMORY

(71) Applicant: WUHAN CHINA STAR OPTOELECTRONICS SEMICONDUCTOR DISPLAY TECHNOLOGY CO., LTD., Wuhan, Hubei (CN)

(72) Inventor: Li TAN, Wuhan, Hubei (CN)

(21) Appl. No.: 15/736,164

(22) PCT Filed: Nov. 28, 2017
(86) PCT No.: PCT/CN2017/113411

§ 371 Date: Dec. 13, 2017

(30) Foreign Application Priority Data
Nov. 21, 2017 (CN) 201711162560.7

(51) Int. Cl. G09G 3/36

(52) U.S. Cl. CPC G09G 3/3607; G09G 2360/16; G09G 2320/0626; G09G 2360/147; G09G 2320/0233

(57) ABSTRACT

A device and a method for brightness compensation and a memory are provided. The method includes: collecting grayscale images corresponding to each of the N grayscales; obtaining brightness values of M pixel points of each of the N grayscale images; grouping the M pixel points according to the brightness values of each of the M pixel points under N grayscales to obtain a plurality of pixel groups; calculating a brightness compensation factor of the pixel group under each grayscale according to an average brightness value of each pixel group under each grayscale to obtain the brightness compensation factors of each pixel group under N grayscales respectively; and building a lookup table of the brightness compensation factor according to the brightness compensation factors. The brightness compensation method provided in the disclosure improves the brightness evenness and the display effect of the display, and saves the storage space of the display.

### RELATED APPLICATIONS

The present application is a National Phase of International Application Number PCT/CN2017/113411, filed Nov. 28, 2017, and claims the priority of China Application No. 201711162560.7, filed Nov. 21, 2017.

### FIELD OF THE DISCLOSURE

The disclosure relates to the field of liquid crystal display technology, and in particular to a device and a method for brightness compensation and a memory.

### BACKGROUND

Due to process reasons, the consistency of each pixel of OLED products is poor. OLED products without any treatment will have more serious brightness unevenness (MURA). Therefore, each OLED product need to be compensated for brightness (DEMURA) before leaving the factory.

At present, the method of DEMURA is mainly to take pictures through a high-performance CCD optical camera for each pixel of OLED products under a plurality of specific grayscales. The GAMMA curve of each pixel point is fitted by the brightness of the pixel point under these grayscales. By fitting the GAMMA curve with the standard curve 2.2, the brightness compensation factor of the pixel is obtained. The brightness compensation factor of all the pixels are recorded into the FLASH of the display. When the OLED product displays, the DRIVER IC will compensate the brightness of the corresponding pixel according to the information in the FLASH, so as to improve the uneven brightness. In this method, the brightness compensation factor needs to be pre-stored for each pixel, and the required storage capacity is large. However, due to limited internal space, the layout of a large capacity storage area of the DRIVER IC faces great difficulties in design difficulty and cost. Moreover, the GAMMA curve of each pixel is fitted according to the brightness values under several grayscales, which may not be actually accurate. Even though the fitted GAMMA curve is accurate, according to the brightness compensation factor obtained from the fitted GAMMA curve and the standard curve is not necessarily applicable to the compensation under all of the grayscales, the final display effect after compensation has a great deal of uncertainty.

### SUMMARY

In order to solve the deficiencies of the prior art, the disclosure provides a device and method for brightness compensation and a memory, which can improve the brightness unevenness of a display, improve the display effect of the display, and save the storage space of the display.

A specific technical proposal of this disclosure is to provide a method for brightness compensation, and the method includes the following steps:

collecting grayscale images corresponding to each of the N grayscales to obtain N grayscale images;

obtaining brightness values of M pixel points of each of the N grayscale images to obtain the brightness values of each of the M pixel points under N grayscales;

grouping the M pixel points according to the brightness values of each of the M pixel points under N grayscales to obtain a plurality of pixel groups;

calculating a brightness compensation factor of each of the plurality of pixel group under each of the grayscale according to an average brightness value of the pixel groups under each of the grayscales to obtain brightness compensation factors of each of the plurality of pixel groups under N grayscales respectively; and

building a lookup table of the brightness compensation factor according to the brightness compensation factor of each of the plurality of pixel groups under N grayscales respectively.

Optionally, the step of grouping the M pixel points according to the brightness values of each of the M pixel points under N grayscales to obtain a plurality of pixel groups specifically includes:

fitting brightness values of each of the M pixel points under N grayscales to obtain a brightness fitting curve corresponding to each of the pixel points respectively;

calculating a cross-correlation coefficient between a brightness fitting curve corresponding to each of the M pixel points and a brightness fitting curve corresponding to the other of the M pixel points, and grouping the other pixel points having the cross-correlation coefficient greater than the first threshold with the pixel point; and

sequentially grouping the un-grouped pixel points of the M pixel points until all of the M pixel points are grouped to obtain a plurality of pixel groups.

Optionally, the method for fitting the brightness values of each of the M pixel points under N grayscales is a polynomial fitting method.

Optionally, the step of grouping the M pixel points according to the brightness values of each of the M pixel points under N grayscales to obtain a plurality of pixel groups specifically includes:

calculating a difference between the brightness values of any two of the M pixel points under each of the grayscales;

grouping the two of the pixel points into one group when the difference between the brightness values of any two of the M pixel points under each of the grayscales is less than a second threshold; and

sequentially grouping the un-grouped pixel points of the M pixel points until all of the M pixel points are grouped to obtain a plurality of pixel groups.

Optionally, after the step of building a lookup table of the brightness compensation factor according to the brightness compensation factor of each of the plurality of pixel groups under N grayscales respectively, the method further includes: storing the lookup table of the brightness compensation factor.

Optionally, a value corresponding to each row in the lookup table of the brightness compensation factor is an offset amount of brightness compensation factors of the pixel group corresponding to the row and the pixel group corresponding to the previous row respectively under N grayscales.

Optionally, a value corresponding to each column in the lookup table of the brightness compensation factor is an offset amount of brightness compensation factors of the pixel group corresponding to the column and the pixel group corresponding to the previous column respectively under N grayscales.

The disclosure also provides a device for brightness compensation, and the device includes:

a collecting module, configured to collect grayscale images corresponding to each of the N grayscales to obtain N grayscale images;

a brightness acquiring module, configured to acquire brightness values of M pixel points of each of the N grayscale images to obtain a brightness value of each of the M pixel points under N grayscales;

a grouping module, configured to group the M pixel points according to brightness values of each of the M pixel points under N grayscales to obtain a plurality of pixel groups;

a calculating module, configured to calculate a brightness compensation factor of each of the plurality of pixel groups in each of the grayscales according to an average brightness value of the pixel group under each of the grayscales to obtain brightness compensation factors of each of the plurality of pixel groups under N grayscales respectively;

a table building module, configured to build a lookup table of the brightness compensation factor according to the brightness compensation factor of each of the plurality of pixel groups under N grayscales respectively.

Optionally, the collecting module is a CCD.

The disclosure also provides a memory, in which a plurality of instructions are stored, and the plurality of instructions is adapted for being loaded and executed by a processor. The instructions are as follows:

collecting grayscale images corresponding to each of the N grayscales to obtain N grayscale images;

obtaining brightness values of M pixel points of each of the N grayscale images to obtain the brightness values of each of the M pixel points under N grayscales;

grouping the M pixel points according to the brightness values of each of the M pixel points under N grayscales to obtain a plurality of pixel groups;

calculating a brightness compensation factor of each of the plurality of pixel group under each of the grayscale according to an average brightness value of the pixel groups under each of the grayscales to obtain brightness compensation factors of each of the plurality of pixel groups under N grayscales respectively; and

building a lookup table of the brightness compensation factor according to the brightness compensation factor of each of the plurality of pixel groups under N grayscales respectively.

The brightness compensation method proposed by the disclosure is to obtain the brightness compensation factors of the grouped pixel groups under each of grayscales by grouping different pixel points, and build a lookup table of the brightness compensation factor according to the brightness compensation factor of each of the plurality of pixel groups under each of grayscales; in the subsequent brightness compensation, it is only required to obtain the brightness compensation factor of the pixel group under the grayscale according to the group number and the grayscale of the pixel group where the pixel point is located, and each of the pixel points corresponds to a brightness compensation factor under each grayscale, which improves the brightness evenness of the display, improves the display effect of the display, and simultaneously, and saves the storage space of the display by grouping.

### BRIEF DESCRIPTION OF THE DRAWINGS

FIG. 1 is a flow chart of a method of brightness compensation in Embodiment 1;

FIG. 2 is a schematic structural view of the apparatus for brightness compensation in Embodiment 1;

FIG. 3 is a schematic structural view of a grouping module in Embodiment 1; and

FIG. 4 is a schematic structural view of a memory and a processor in Embodiment 1.

### DETAILED DESCRIPTION OF PREFERRED EMBODIMENTS

Hereinafter, embodiments of the disclosure will be described in detail with reference to the accompanying drawings. This disclosure may, however, be embodied in many different forms and should not be construed as limited to the embodiments set forth herein. Rather, these embodiments are provided to explain the principles of the disclosure and its practical application so as to enable those skilled in the art to understand the various embodiments of the disclosure and various modifications that are suitable for a specific intended application. In the drawings, the same reference numerals will always be used to indicate the same elements.

### Embodiment 1

Referring to FIG. 1, the method for brightness compensation provided in this embodiment includes the following steps:

S1: collecting grayscale images corresponding to each of the N grayscales to obtain N grayscale images;

S2: obtaining brightness values of M pixel points of each of the N grayscale images to obtain the brightness values of each of the M pixel points under N grayscales;

S3: grouping the M pixel points according to the brightness values of each of the M pixel points under N grayscales to obtain a plurality of pixel groups;

S4: calculating a brightness compensation factor of each of the plurality of pixel group under each of the grayscale according to an average brightness value of the pixel groups under each of the grayscales to obtain brightness compensation factors of each of the plurality of pixel groups under N grayscales respectively;

S5: building a lookup table of the brightness compensation factor according to the brightness compensation factor of each of the plurality of pixel groups under N grayscales respectively.

In step S1, the number of the grayscales is 256, so 256 grayscale images respectively corresponding to the grayscales need to be collected, that is, 256 grayscale images need to be collected.

In step S2, the number of the pixel points is determined according to the resolution of the display, the higher the resolution of the display screen is, the larger the number of pixel points is, that is, the value of M is relatively large; the lower the resolution of the display screen is, the smaller the number of the pixel points is, that is, the value of M is relatively small. The brightness value of the M pixel points under N grayscales can be obtained by obtaining the brightness values of the M pixel points of each grayscale image, and in this embodiment, the brightness value of the ith pixel under the jth grayscale is xᵢⱼ, 1≤i≤M, 1≤j≤N.

As an example, when the value of M is 5 and the value of N is 3, and the brightness values of 5 pixel points under 3 grayscales are (x₁₁,y₁₂,z₁₃), (x₂₁,y₂₂,z₂₃), (x₃₁,y₃₂,z₃₃), (x₄₁,y₄₂,z₄₃), (x₅₁,y₅₂,z₅₃). In step S3, the first pixel point, the second pixel point, and the fourth pixel point belong to the first pixel group, and the third pixel point and the fifth pixel point belong to the second pixel group. In step S4, the average brightness values of the first pixel group under three grayscales are respectively,

$$\frac{{x}_{11} + {x}_{21} + {x}_{41}}{3} , \frac{{x}_{12} + {x}_{22} + {x}_{42}}{3} and \frac{{x}_{13} + {x}_{23} + {x}_{43}}{3} .$$

The average brightness value of the second pixel group under the three gray scales respectively

$$\frac{{x}_{31} + {x}_{51}}{2} , \frac{{x}_{32} + {x}_{52}}{2} , and \frac{{x}_{33} + {x}_{53}}{2} .$$

According to an average brightness value of each pixel group under each grayscale, a brightness compensation factor of the pixel group under each grayscale is calculated.

In step S4, the brightness compensation factor is obtained in the following manner in the embodiment. Firstly, the brightness value of the standard curve 2.2 under each of the grayscales is obtained, and then the average brightness value of each of the pixel groups under each of the grayscales is obtained, finally, according to the average brightness value of each of the pixel groups under each of the grayscales and the brightness value of the standard curve 2.2 under each of the grayscales, the brightness compensation factors of the pixel group under each of the grayscales are obtained respectively. For example, assuming that the average brightness value of the standard curve 2.2 under 32-bit grayscale is A, and the average brightness value of the first pixel group under 32-bit grayscale is B, then the brightness compensation factor of the first pixel group under 32-bit grayscale is δ=A/B. Here, the brightness compensation factor can also be calculated by other existing methods, which is not limited herein. After calculation, the brightness compensation factors of the first pixel group under three grayscales are obtained as δ₁₁, δ₁₂, δ₁₃, and the brightness compensation factors of the second pixel group under three grayscales are obtained as δ₂₁, δ₂₂, δ₂₃.

In step S5, each of the pixel groups is numbered, a lookup table of the brightness compensation factor is built according to the brightness compensation factor of each of the pixel groups under each of the grayscales so that the lookup table of the brightness compensation factor can be directly called later, and the following table shows an example of the lookup table of the brightness compensation factor

TABLE 1
Lookup Table of Brightness Compensation Factor

| | Grayscale | | |
|---|---|---|---|
| Pixel Point | 1 | 2 | 3 |
| 1 | δ₁₁ | δ₁₂ | δ₁₃ |
| 2 | δ₂₁ | δ₂₂ | δ₂₃ |

After step S5, the brightness compensation method further includes storing a lookup table of the brightness compensation factor, and the lookup table of the brightness compensation factor is recorded to the flash of the display, and the lookup table of the brightness compensation factor can be directly called when the brightness compensation of the display is performed.

By grouping the different pixel points, a brightness compensation factor under each of grayscales of the grouped pixel group is obtained, and a lookup table of the brightness compensation factor is built according to the brightness compensation factor of each of the plurality of pixel groups under each of grayscales. In the subsequent brightness compensation, it is only required to obtain the brightness compensation factor of the pixel group under the grayscale according to the group number and the grayscale of the pixel group where the pixel point is located, and each pixel corresponds to a brightness compensation factor under each grayscale, thereby improving the evenness of the brightness of the display and improving the display effect of the display, and simultaneously, saving the storage space of the display by grouping.

Specifically, step S3 includes:

S31: fitting brightness values of each of the M pixel points under N grayscales to obtain a brightness fitting curve corresponding to each of the pixel points respectively; here, the method for fitting the brightness values of N grayscales to each of the M pixel points is a polynomial fitting method. As an example, assuming that three grayscales are 32-bit grayscale, 64-bit grayscale, and 128-bit grayscale, then the three fitting points corresponding to the first pixel point is (32, x₁₁), (64, y₁₂), and (128, z₁₃), and the fitting polynomial is f(x)=ax²+bx+c. The value of a, b, c can be determined according to the three fitting points, so as to obtain the brightness fitting curve of the first pixel point. The brightness fitting curves of the second, the third, the fourth and the fifth pixel points can be sequentially obtained by repeating the above process.

S32: calculating a cross-correlation coefficient between a brightness fitting curve corresponding to each of the M pixel points and a brightness fitting curve corresponding to the other of the M pixel points, and grouping the other pixel points having the cross-correlation coefficient greater than the first threshold with the pixel point. As an example, the first threshold is 0.9, the cross-correlation coefficients between the brightness fitting curve of the first pixel point and the brightness fitting curves of the second pixel point, the third pixel point, the fourth pixel point, and the fifth pixel point are respectively calculated. The correlation coefficients between the first pixel point and the second and the fourth pixel points are both greater than 0.9, then the first, the second, and the fourth pixel points belong to the first pixel group.

S33: repeating step S32, sequentially grouping the un-grouped pixel points of the M pixel points until all of the M pixel points are grouped to obtain a plurality of pixel groups, that is, the third and fifth pixel groups are grouped to calculate whether the cross-correlation coefficient between the brightness fitting curves of the third pixel point and the fifth pixel point is greater than 0.9; when the coefficient is greater than 0.9, the third and fifth pixel points belong to the second pixel group, when the coefficient is not greater than 0.9, the third pixel belongs to the second pixel group, and the fifth pixel belongs to the third pixel group; in the embodiment, it is assumed that the third and the fifth pixel points belong to the second pixel group.

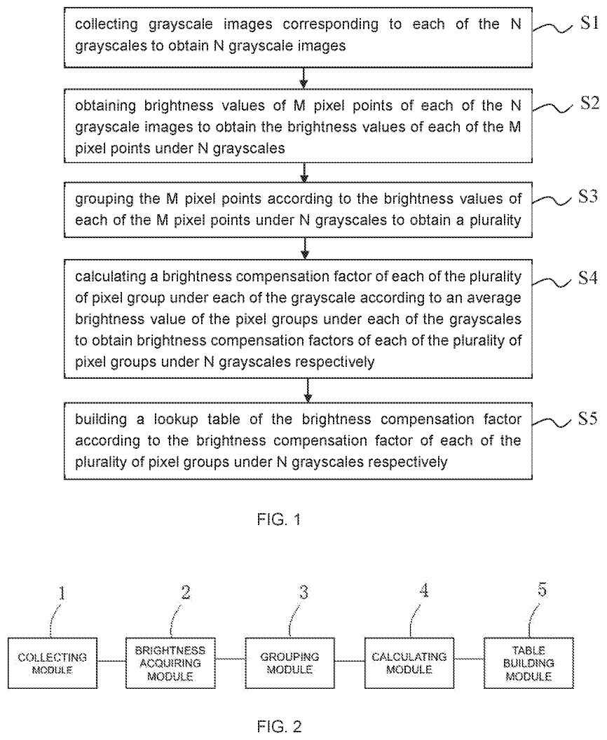

Referring to FIG. 2, the device for brightness compensation provided in this embodiment includes a collecting module 1, a brightness acquiring module 2, a grouping module 3, a calculating module 4, and a table building module 5.

The collecting module 1 is configured to collect grayscale images corresponding to each of the N grayscales to obtain N grayscale images. The brightness acquiring module 2 is configured to acquire brightness values of M pixel points of each of the N grayscale images to obtain a brightness value of each of the M pixel points under N grayscales. The grouping module 3 is configured to group the M pixel points according to brightness values of each of the M pixel points under N grayscales to obtain a plurality of pixel groups. The calculating module 4 is configured to calculate a brightness compensation factor of the pixel group in each gray scale according to an average brightness value of each pixel group in each of the plurality of pixel groups under each gray scale to obtain a plurality of pixel groups. The brightness compensation factor of each pixel group under N gray scales respectively. The table building module 5 is configured to build a lookup table of the brightness compensation factor according to the brightness compensation factor of each of the plurality of pixel groups under N grayscales respectively. The collecting module 1 in this embodiment is a CCD.

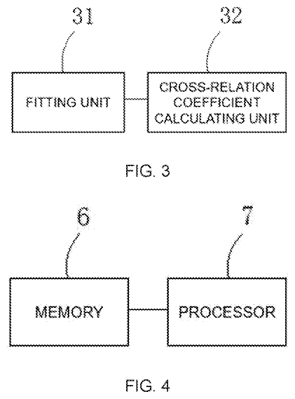

Referring to FIG. 3, the grouping module 3 further includes a fitting unit 31 and a cross-correlation coefficient calculating unit 32. The fitting unit 31 is configured to fit the brightness values of each of the M pixel points under N grayscales to obtain a brightness fitting curve corresponding to each of the pixel points respectively. The cross-correlation coefficient calculating unit 32 is configured to calculate a cross-correlation coefficient between a brightness fitting curve corresponding to each of the M pixel points and a brightness fitting curve corresponding to the other of the M pixel points.

Referring to FIG. 4, the embodiment further provides a memory 6, and a plurality of instructions are stored therein, and the plurality of instructions is adapted for being loaded and executed by a processor. The instructions are as follows: collecting grayscale images corresponding to each of the N grayscales to obtain N grayscale images; obtaining brightness values of M pixel points of each of the N grayscale images to obtain the brightness values of each of the M pixel points under N grayscales; grouping the M pixel points according to the brightness values of each of the M pixel points under N grayscales to obtain a plurality of pixel groups; calculating a brightness compensation factor of the pixel group at each of the grayscale according to an average brightness value of each of the plurality of pixel groups at each of the grayscales to obtain brightness compensation factors of each of the plurality of pixel groups under N grayscales respectively; and building a lookup table of the brightness compensation factor according to the brightness compensation factor of each of the plurality of pixel groups under N grayscales respectively.

### Embodiment 2

The difference between this embodiment and Embodiment 1 lies in the grouping method adopted and the method for building a lookup table of the brightness compensation factor.

Step S3 in this embodiment includes:

S31: calculating a difference between the brightness values of any two of the M pixel points under each of the grayscales. As an example, the brightness values of the five pixel points in the three grayscales are (x₁₁,y₁₂,z₁₃), (x₂₁,y₂₂,z₂₃), (x₃₁,y₃₂,z₃₃), (x₄₁,y₄₂,z₄₃), and (x₅₁,y₅₂,z₅₃), and the difference between the brightness values of the first pixel and the second, third, fourth, and fifth pixels under the three grayscales as x₁₁−x₂₁,y₁₂−y₂₂,z₁₃−z₂₃, x₁₁−x₃₁,y₁₂−y₃₂,z₁₃−z₃₃, x₁₁−x₄₁,y₁₂−y₄₂,z₁₃−z₄₃, and x₁₁−x₅₁,y₁₂−y₅₂,z₁₃−z₅₃.

S32: grouping the two pixel points into one group when the difference between the brightness values of any two of the M pixel points under each of the grayscales is less than a second threshold; as an example, the second threshold value is 2, when x₁₁−x₂₁≤2,y₁₂−y₂₂≤2,z₁₃−z₂₃≤2, x₁₁−x₄₁≤2,y₁₂−y₄₃≤2,z₁₃−z₄₃≤2, then the first, second, and fourth pixel points belong to a first pixel group;

S33: repeating step S32, sequentially grouping the un-grouped pixel points of the M pixel points until all of the M pixel points are grouped to obtain a plurality of pixel groups, that is, the third and fifth pixel groups are grouped, and the difference between the brightness values of the third pixel point and the fifth pixel point under three grayscales are calculated respectively as x₃₁−x₅₁,y₃₂−y₅₂,z₃₃−z₅₃; if x₃₁−x₅₁≤2,y₃₂−y₅₂≤2,z₃₃−z₅₃≤2 is satisfied, the third and fifth pixel points belong to the second pixel group; if not, the third pixel belongs to the second pixel group, and the fifth pixel belongs to the third pixel group; in the embodiment, it is assumed that the third and fifth pixel points belong to the second pixel group.

In step S5 of the embodiment, each of the pixel groups is numbered, a lookup table of the brightness compensation factor is built according to the brightness compensation factor of each of the pixel groups under each of the grayscales. Here, a value corresponding to each row in the lookup table of the brightness compensation factor is an offset amount of the brightness compensation factor between the pixel group corresponding to the row and the pixel group corresponding to the previous row respectively under N grayscales. The following table is taken as an example.

TABLE 2
Lookup Table of Brightness Compensation Factor

| | Grayscale | | |
|---|---|---|---|
| Pixel Point | 1 | 2 | 3 |
| 1 | δ₁₁ | δ₁₂ | δ₁₃ |
| 2 | 2 | −1 | 1 |

Here, the brightness compensation factors of the second pixel group under the three grayscale are respectively δ₂₁=δ₁₁+2, δ₂₂=δ₁₂−1, and δ₂₃=δ₁₃=+1. Since the difference of the brightness compensation factor between the two pixel groups is not too large, the storage space can be further saved by building the lookup table of the brightness compensation factor by the offset amounts of the brightness compensation factor of the pixel groups under N grayscales.

In this embodiment, the lookup table of the brightness compensation factor can also be built according to a value corresponding to each column in the lookup table of the brightness compensation factor is an offset amount of brightness compensation factor between the pixel group corresponding to the column and the pixel group corresponding to the previous column under N grayscales respectively, as shown in the Table 3.

TABLE 3
Lookup Table of The Brightness Compensation Factor

| | Grayscale | | |
|---|---|---|---|
| Pixel Point | 1 | 2 | 3 |
| 1 | δ₁₁ | 3 | 1 |
| 2 | δ₂₁ | 2 | −1 |

Here, the brightness compensation factors of the first pixel group under the three grayscale are respectively δ₁₁, δ₁₂=δ₁+3, and δ₁₃=δ₁₂ 1=δ₁₁+4, and the brightness compensation factors of the second pixel group under the three grayscale respectively δ₂₁, δ₂₂=δ₂₁+2, and δ₂₃=δ₂₂-1=δ₂₁+1.

Of course, it is also possible to build a lookup table of the brightness compensation factor by defining the offset amount of the brightness compensation factor of other modes.

It should be indicated that the present application can also be improved and modified by those skilled in the art without departing from the principle of the present application, and these improvements and modifications also fall within the protection scope of the claims of the present application.

What is claimed is:

1. A method for brightness compensation, comprising the steps of:
collecting grayscale images corresponding to each of N grayscales to obtain N grayscale images;
obtaining brightness values of M pixel points of each of the N grayscale images to obtain the brightness values of each of the M pixel points under N grayscales;
grouping the M pixel points according to the brightness values of each of the M pixel points under N grayscales to obtain a plurality of pixel groups;
calculating a brightness compensation factor of each of the plurality of pixel groups under each of the grayscale according to an average brightness value of the pixel group under each of the grayscales to obtain brightness compensation factors of each of the plurality of pixel groups under N grayscales respectively; and
building a lookup table of the brightness compensation factor according to the brightness compensation factor of each of the plurality of pixel groups under N grayscales respectively.

2. The method according to claim 1, wherein the step of grouping the M pixel points according to the brightness values of each of the M pixel points under N grayscales to obtain a plurality of pixel groups specifically comprises:
fitting the brightness values of each of the M pixel points under N grayscales to obtain a brightness fitting curve corresponding to each of the pixel points respectively;
calculating a cross-correlation coefficient between a brightness fitting curve corresponding to each of the M pixel points and a brightness fitting curve corresponding to the other of the M pixel points, and grouping the other pixel points having the cross-correlation coefficient greater than a first threshold with the pixel point; and
sequentially grouping the un-grouped pixel points of the M pixel points until all of the M pixel points are grouped to obtain a plurality of pixel groups.

3. The method according to claim 2, wherein the method for fitting the brightness values of each of the M pixel points under N grayscales is a polynomial fitting method.

4. The method according to claim 1, wherein the step of grouping the M pixel points according to the brightness values of each of the M pixel points under N grayscales to obtain a plurality of pixel groups specifically comprises:
calculating a difference between the brightness values of any two of the M pixel points under each of the grayscales;
grouping the two pixel points into one group when the difference between the brightness values of the two pixel points under each of the grayscales is less than a second threshold; and
sequentially grouping the un-grouped pixel points of the M pixel points until all of the M pixel points are grouped, so as to obtain a plurality of pixel groups.

5. The method according to claim 1, wherein after the step of building a lookup table of the brightness compensation factor according to the brightness compensation factor of each of the plurality of pixel groups under N grayscales respectively, the method further comprises storing the lookup table of the brightness compensation factor.

6. The method according to claim 5, wherein a value corresponding to each row in the lookup table of the brightness compensation factor is an offset amount of brightness compensation factor between the pixel group corresponding to the row and the pixel group corresponding to the previous row respectively under N grayscales.

7. The method according to claim 5, wherein a value corresponding to each column in the lookup table of the brightness compensation factor is an offset amount of brightness compensation factor between the pixel group corresponding to the column and the pixel group corresponding to the previous column under N grayscales respectively.

8. A device for brightness compensation, comprising:
a collecting module, configured to collecting grayscale images corresponding to each of the N grayscales to obtain N grayscale images;
a brightness acquiring module, configured to acquire brightness values of M pixel points of each of the N grayscale images to obtain a brightness value of each of the M pixel points under N grayscales;
a grouping module, configured to group the M pixel points according to brightness values of each of the M pixel points under N grayscales to obtain a plurality of pixel groups;
a calculating module, configured to calculate a brightness compensation factor of the pixel group in each grayscale according to an average brightness value of each of the plurality of pixel groups under each grayscale to obtain brightness compensation factors of each of the plurality of pixel groups under N grayscales respectively; and
a table building module, configured to build a lookup table of the brightness compensation factor according to the brightness compensation factor of each of the plurality of pixel groups under N grayscales respectively.

9. The device according to claim 8, wherein the collecting module is a CCD.

10. A memory, wherein a plurality of instructions stored in the memory, and the plurality of instructions is adapted for being loaded and executed by a processor, the instructions are as follows:
collecting grayscale images corresponding to each of the N grayscales to obtain N grayscale images;
obtaining brightness values of the M pixel points of each of the N grayscale images to obtain the brightness values of each of the M pixel points under N grayscales;
grouping M pixel points according to the brightness values of each of the M pixel points under N grayscales to obtain a plurality of pixel groups;
calculating a brightness compensation factor of each of the plurality of pixel group under each of the grayscale according to an average brightness value of the pixel groups under each of the grayscales to obtain brightness compensation factors of each of the plurality of pixel groups under N grayscales respectively; and
building a lookup table of the brightness compensation factor according to the brightness compensation factor of each of the plurality of pixel groups under N grayscales respectively.
